(19) United States
(12) Patent Application Publication
(10) Pub. No.: US 2025/0115409 A1
(43) Pub. Date: Apr. 10, 2025

(54) MULTI-CONFIGURATION, REUSABLE BOTTLE ASSEMBLY

(71) Applicant: Proja IP LLC, Brooklyn, NY (US)

(72) Inventor: Joseph Abadi, Brooklyn, NY (US)

(73) Assignee: Proja IP LLC, Brooklyn, NY (US)

(21) Appl. No.: 18/204,682

(22) Filed: Jun. 1, 2023

Related U.S. Application Data
(60) Provisional application No. 63/476,805, filed on Dec. 22, 2022.

(51) Int. Cl. B65D 81/38; B65D 1/40

(52) U.S. Cl. CPC B65D 81/3876; B65D 1/40

(57) ABSTRACT

A multi-configuration, reusable bottle assembly is provided, having a metal bottle and a glass bottle that can be nested therein and covered by a bottle cap. The metal bottle is formed of an upper portion that removably mates with a lower portion in a watertight manner to define an interior volume for retaining liquid. When detached, the upper portion and the lower portion can both independently serve as cups for retaining liquid. The lower portion is further configured to serve as a thermally insulative sleeve (aka, can cooler, koozie) for standard beverage containers such as soda cans or beverage bottles. In this manner, the reusable bottle assembly provides multiple and varied uses to meet the user's needs.

### CROSS REFERENCE TO RELATED APPLICATION

This application claims the benefit of U.S. App. No. 63/476,805, filed Dec. 22, 2022, which is incorporated by reference.

### FIELD OF THE INVENTION

The present invention relates generally to reusable bottles and, more particularly, to a reusable bottle assembly having multiple configurations.

### BACKGROUND OF THE INVENTION

Reusable bottles have grown in popularity, as they offer a range of benefits, both for individuals and the environment. Using reusable bottles significantly reduces the consumption of single-use plastic bottles, which helps reduce plastic waste and its negative impact on the environment. Refilling your reusable bottle with tap water or other beverages is generally more economical than buying bottled drinks.

Given their popularity, reusable bottles come in various shapes, sizes, and designs, to suit particular usages, preferences, and needs. Stainless steel reusable bottles and glass reusable bottles are both popular choices for individuals looking to reduce their consumption of single-use plastic bottles. While they serve a similar purpose, there are some differences.

Stainless steel bottles are highly durable and can withstand rough handling, making them suitable for outdoor activities and sports. Glass bottles are relatively fragile and can break if dropped or subjected to impact. They require careful handling to prevent damage. Stainless steel bottles often come with double-walled insulation, which helps keep beverages hot or cold for extended periods. They are ideal for keeping drinks at the desired temperature.

Stainless steel bottles are generally lighter than glass bottles due to the nature of the material. This may be a consideration for individuals who prioritize lightweight options for backpacking or traveling. Given the variety of bottles and usages, users often have several different types of reusable bottles.

It should, therefore, be appreciated that there remains a need for a multi-configuration, reusable bottle assembly that addresses these issues and others.

### SUMMARY OF THE INVENTION

Briefly, and in general terms, the present invention provides multi-configuration, reusable bottle assembly having a metal bottle and a glass bottle that can be nested therein and covered by a bottle cap. The metal bottle is formed of an upper portion that removably mates with a lower portion in a watertight manner to define an interior volume for retaining liquid. When detached, the upper portion and the lower portion can both independently serve as cups for retaining liquid. The lower portion is further configured to serve as a thermally insulative sleeve (aka, can cooler, koozie) for standard beverage containers such as soda cans or beverage glass bottles (beer bottle, etc.). In this manner, the reusable bottle assembly provides multiple and varied uses to meet the user's needs.

More specifically, in an exemplary embodiment, the glass bottle further sized to extend out the opening of the metal bottle so that an opening of the glass bottle directly mates with the bottle cap, forming a watertight seal therebetween. This allows the user to drink directly from the glass bottle, their lips never coming into contact with anything other than the glass bottle.

In a detailed aspect of an exemplary embodiment, the bottle cap includes a cylindrical base that mates with the neck of the metal bottle, a flip top that is attached to the base via a hinge, and a latch that engages the base and the flip top for securing the flip top, the flip top is positioned to seal the opening of the glass bottle in a watertight manner, when closed

In another detailed aspect of an exemplary embodiment, the upper portion defines a bottom opening and includes threads disposed about an outer side a sidewall of thereof, proximate to the bottom opening. The lower portion defines a top opening and includes threads disposed on an inner side of a sidewall thereof, proximate to the top opening, to mate with the threads of the upper portion forming a watertight seal therebetween.

In yet another detailed aspect of an exemplary embodiment, the glass bottle includes a first sleeve disposed about the neck of the glass bottle, and a second sleeve disposed about a base of the glass bottle. The first sleeve and the second sleeve of the glass bottle contact the interior side of the metal bottle in a snug-fit manner, when the glass bottle nested therein.

For the purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of a reusable bottle assembly in accordance with the invention, depicting a bottle cap closed.

FIG. 2 is a perspective view of the reusable bottle assembly of FIG. 1, depicting the bottle cap flipped open showing the neck of the glass bottle nested with the metal bottle.

FIG. 3 is an exploded perspective view of the reusable bottle assembly of FIG. 1.

FIG. 4 is a cross-sectional view of the reusable bottle assembly of FIG. 1, with the bottle cap removed.

FIG. 5 is a perspective view of the reusable bottle assembly of FIG. 1, depicting the lower portion of the metal bottle assembly serving as a thermal insulator for a packaged beverage, the upper portion of the bottle assembly serving as a cup which can retain liquid or dry goods, and the glass bottle.

FIG. 6 is a perspective view of the reusable bottle assembly of FIG. 1, depicting an alternate bottle cap having a drinking spout and straw.

FIG. 7 is a perspective view of the reusable bottle assembly of FIG. 1, depicting the bottle cap further having a removable spout for use when the glass bottle is removed.

FIG. 8 is an exploded perspective view of the reusable bottle assembly of FIGS. 1 and 7, depicting the bottle cap further having a removable spout for use when the glass bottle is removed.

### DETAILED DESCRIPTION OF THE PREFERRED EMBODIMENTS

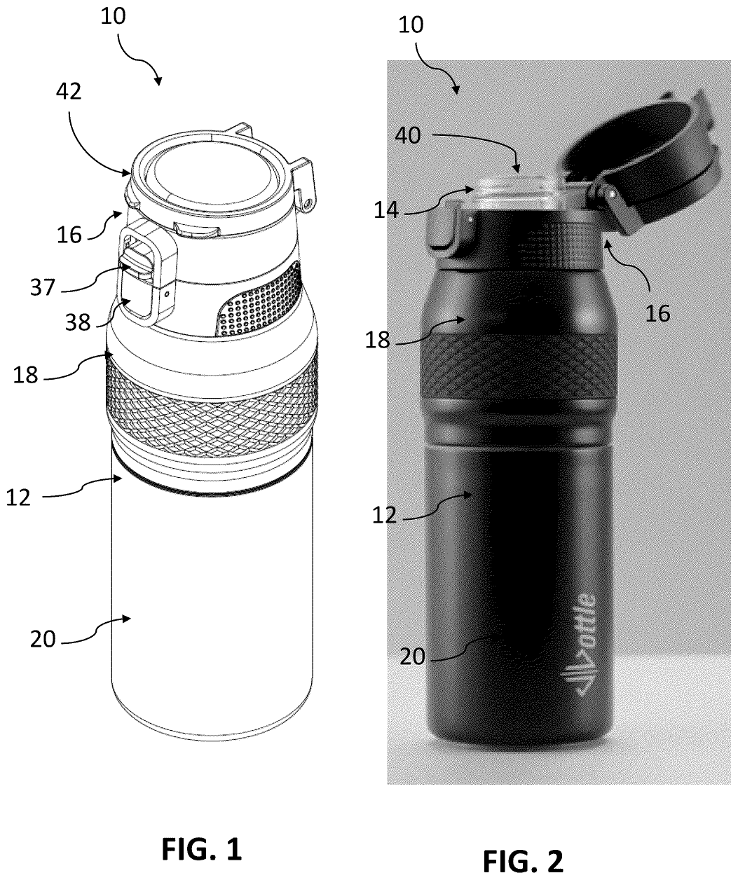

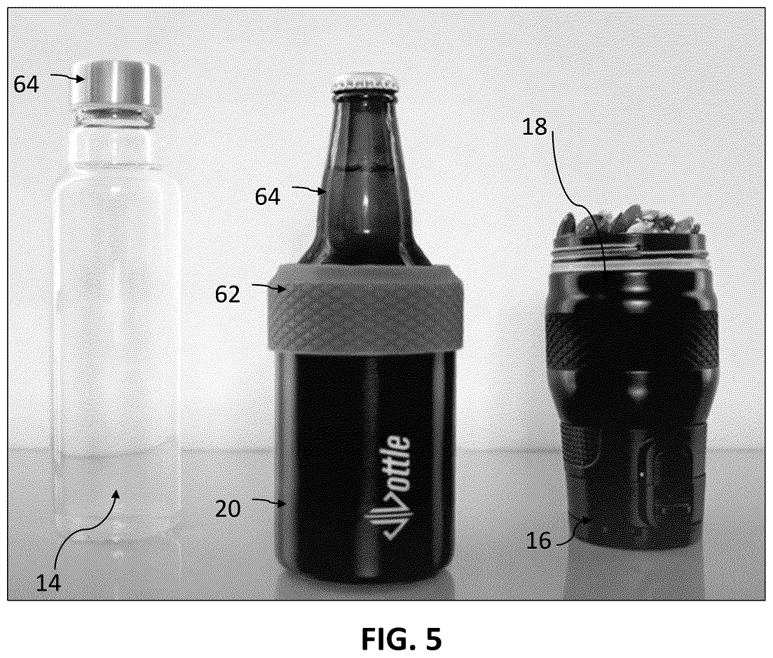

Referring now to the drawings, and particularly FIGS. 1 and 2, there is shown multi-configuration, reusable bottle assembly 10 having a metal bottle 12 and a glass bottle 14 nested therein, covered by a bottle cap 16. The metal bottle 12 is formed of an upper portion 18 that removably mates with a lower portion 20 in a watertight manner to define an interior volume for retaining liquid. When detached, the upper portion and the lower portion can both independently serve as cups for retaining liquid, as further described below. The lower portion is further configured to serve as a thermally insulative sleeve (aka, can cooler, koozie) for standard beverage containers such as soda cans or beverage bottles (FIG. 5). In this manner, the reusable bottle assembly 10 provides multiple and varied uses to meet the user's needs.

For example, the reusable bottle assembly 10 can be used in a first configuration, in which the glass bottle 14 is retained within the metal bottle, with liquid within the glass bottle. In this configuration, the user gains the benefit of liquid retained within the glass bottle, while the metal bottle provides protection and vacuum sealed insulation. The glass bottle is sized to securely and removably nest within the interior volume of the metal bottle. The glass bottle further sized to extend out the opening of the metal bottle so that an opening of the glass bottle directly mates with the bottle cap 16, forming a watertight seal there between. The glass bottle extends above the metal bottle providing a spout allowing the user to drink directly from the glass bottle while it is encased within the metal bottle.

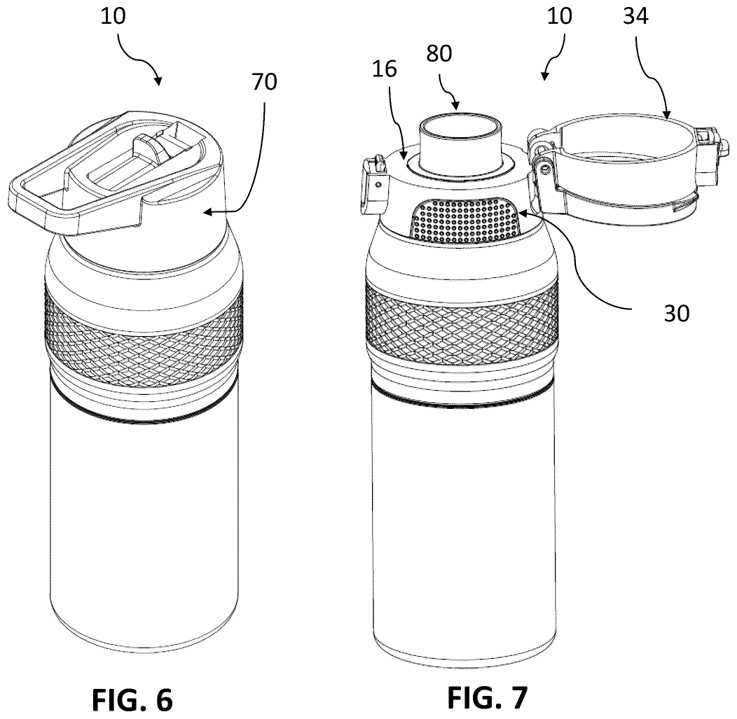

In a second configuration, the reusable bottle assembly 10 can be used, in which the glass bottle is removed. Liquid is stored within an interior volume of the metal bottle and accessed through the bottle cap. Several different types of bottle caps can be used. For example, FIG. 6 depicts the reusable bottle assembly 10 having a bottle cap 70 with a drinking spout and straw.

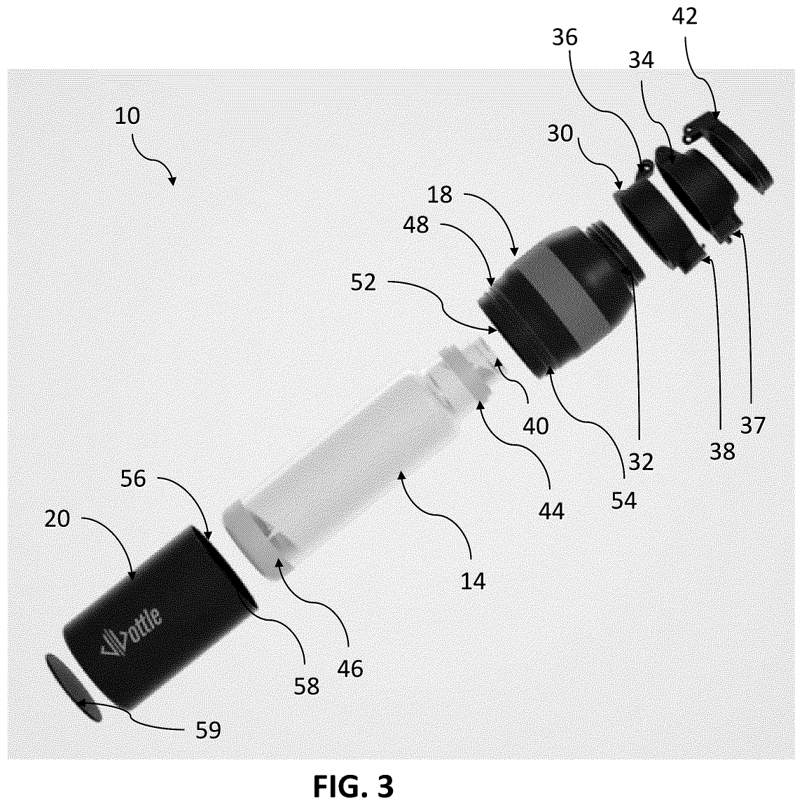

With reference now to FIG. 3, the bottle cap includes a cylindrical base 30 that mates with the neck 32 of the metal bottle 12. A flip top 34 is attached to the base 30 via a hinge 36, and a latch, comprising a lock 37 and push button 38, engages the base and the flip top for securing the flip top. The flip top is positioned to seal the opening 40 of the glass bottle 14 in a watertight manner, when closed. The bottle cap further includes an O-ring 42 atop the flip top that can be used for holding or otherwise securing the bottle assembly. The glass bottle 14 includes a first sleeve 44 disposed about a neck of the glass bottle, and a second sleeve 46 disposed about a base of the glass bottle. The upper portion 18 defines a bottom opening 52 and includes threads 54 disposed about an outer side a sidewall 48 of thereof, proximate to the bottom opening. The lower portion 20 defines a top opening 56 and includes threads 58 disposed on an inner side of a sidewall 50 thereof, proximate to the top opening, to mate with the threads of the upper portion forming a watertight seal therebetween. The lower portion further includes a coaster 59 attached to prevent slipping or scratching surfaces.

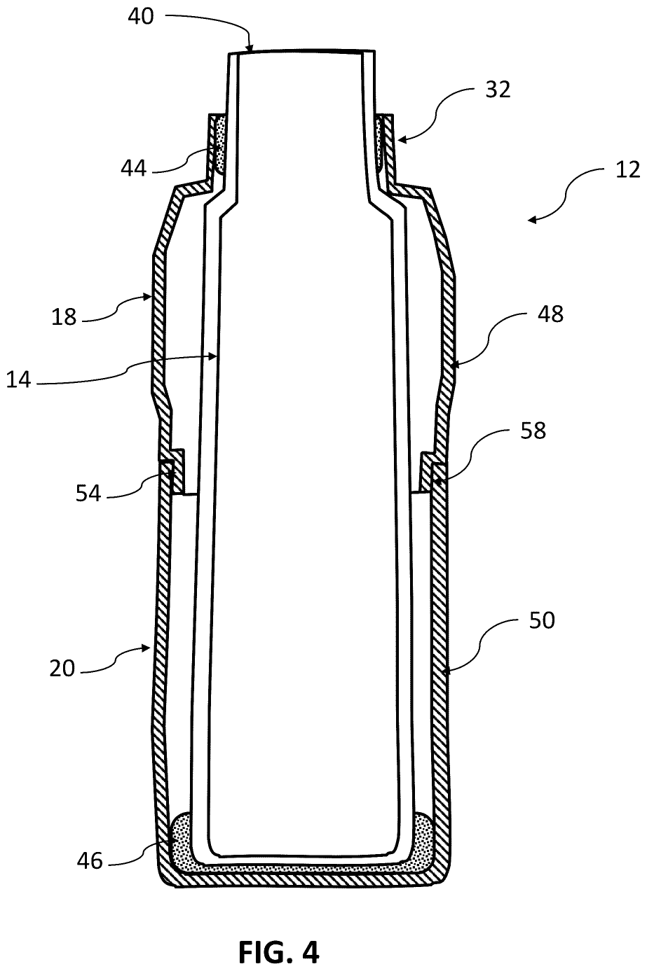

With reference now to FIG. 4, a cross-sectional view of the reusable bottle assembly 10 is shown. The metal bottle 12 has a cylindrical body and an insulative, double-walled side walls. More particularly, the upper portion 18 has a cylindrical body, including an insulative, double-walled side wall 48. The neck 32 includes threads that mate with corresponding threads of the bottle cap 16, shown in FIGS. 1 & 2. The lower portion 20 has a cylindrical body, including an insulative, double-walled side wall 50. The first sleeve 44 and the second sleeve 46 of the glass bottle 14 contact the interior side of the metal bottle in a snug-fit manner, when the glass bottle nested therein. In the exemplary embodiment, the metal bottle is formed of stainless steel, e.g., SS304 material; and the glass bottle is formed of tempered, borosilicate glass.

With reference now to FIG. 5, the lower portion 20 is further configured to serve as a thermally insulative sleeve (aka, can cooler, koozie) for standard beverage containers such as soda cans or beverage bottles 64. In this configuration, a separable silicone grip 62 sized to fit about a top opening of the lower portion 20 of the metal bottle, when separated from the upper portion, serving as a grip, in a can cooler configuration. When detached, the upper portion 16 and the lower portion 20 can both independently serve as cups for retaining liquid or other goods. In this configuration, the bottle cap 16, is retained on the upper portion and provides a flat base. Additionally, the glass bottle 14 is further provided with a threaded bottle cap 64, so that the glass bottle can be used separately. In this manner, the bottle assembly 10 is adaptable for many different uses.

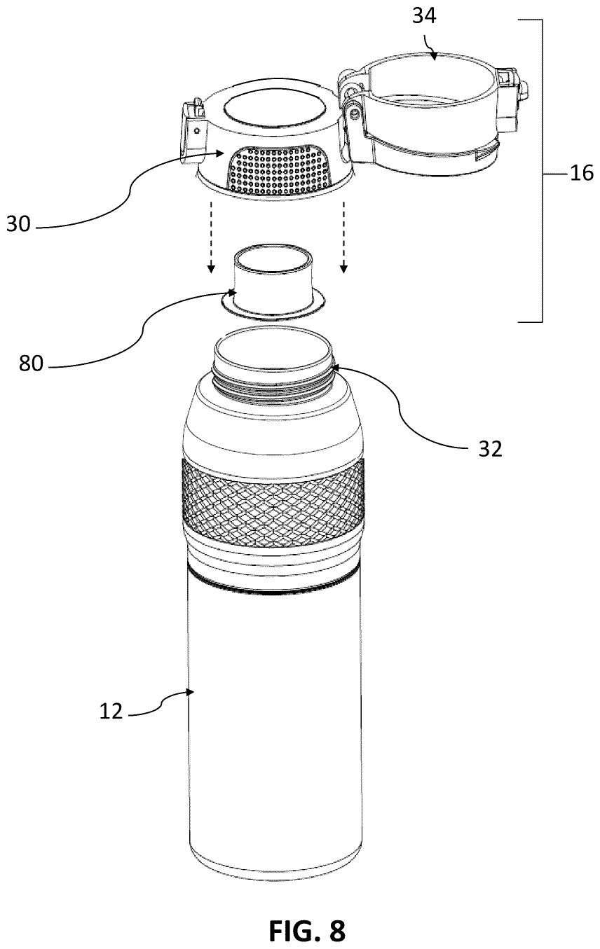

With reference now to FIGS. 7 and 8, the cap 16 further included a removable spout 80 for use when the glass bottle is removed. This enables the user to drink the liquid within the metal bottle. The spout 80 is disposed between the base 30 of the cap 16 and the metal bottle 12 in a watertight matter, when in use. As best seen in FIG. 7, the spout 80 projects upward through an opening of the base 30 for easy use, when the top 34 is flipped open, so that the user can drink directly through the spout when the glass bottle is removed.

It should be appreciated from the foregoing that the present invention provides multi-configuration, reusable bottle assembly having a metal bottle and a glass bottle that can be nested therein and covered by a bottle cap. The metal bottle is formed of an upper portion that removably mates with a lower portion in a watertight manner to define an interior volume for retaining liquid. When detached, the upper portion and the lower portion can both independently serve as cups for retaining liquid. The lower portion is further configured to serve as a thermally insulative sleeve (aka, can cooler, koozie) for standard beverage containers such as soda cans or beverage bottles. In this manner, the reusable bottle assembly provides multiple and varied uses to meet the user's needs

The present invention has been described above in terms of presently preferred embodiments so that an understanding of the present invention can be conveyed. However, there are other embodiments not specifically described herein for which the present invention is applicable. Therefore, the present invention should not be seen as limited to the forms shown, which is to be considered illustrative rather than restrictive.

What is claimed is:

1. A multi-configuration, reusable bottle assembly, comprising:
a bottle cap;
a metal bottle that defines an interior volume for retaining liquid, the metal bottle includes an upper portion and a lower portion that removably mate with each other in a watertight manner to define the interior volume, when detached, the upper portion and the lower portion can both independently serve as cups for retaining liquid, the upper portion includes a neck that defines an opening and that mates with the bottle cap in a watertight manner; and
a glass bottle sized to securely and removably nest within the interior volume of the metal bottle, the glass bottle further sized to extend out the opening of the metal bottle so that an opening of the glass bottle directly mates with the bottle cap, forming a watertight seal therebetween.

2. The multi-configuration, reusable bottle assembly as defined in claim 1, wherein the bottle cap includes a cylindrical base that mates with the neck of the metal bottle, a flip top that is attached to the base via a hinge, and a latch that engages the base and the flip top for securing the flip top, the flip top is positioned to seal the opening of the glass bottle in a watertight manner, when closed.

3. The multi-configuration, reusable bottle assembly as defined in claim 2, wherein the bottle further includes removable spout for use with the glass bottle is removed, the spout is disposed between the base of the cap and the metal bottle in a watertight matter, when in use, the spout projects upward through an opening of the base, when the top is flipped open, so that the user can drink directly through the spout.

4. The multi-configuration, reusable bottle assembly as defined in claim 1, further comprising a separable silicone grip sized to fit about a top opening of the lower portion of the metal bottle, when separated from the upper portion, serving as a grip, in a can cooler configuration.

5. The multi-configuration, reusable bottle assembly as defined in claim 1, wherein the upper portion having a cylindrical body, including an insulative, double-walled side wall, the neck includes threads that mate with corresponding thread of the bottle cap, and the lower portion having a cylindrical body, including an insulative, double-walled side wall.

6. The multi-configuration, reusable bottle assembly as defined in claim 1, wherein:
the upper portion defines a bottom opening and includes threads disposed about an outer side a sidewall of thereof, proximate to the bottom opening, and
the lower portion defines a top opening and includes threads disposed on in inner side of a sidewall thereof, proximate to the top opening, to mate with the treads of the upper opening forming a watertight seal therebetween.

7. The multi-configuration, reusable bottle assembly as defined in claim 1, wherein the glass bottle includes a first sleeve disposed about a neck of the glass bottle, and a second sleeve disposed about a base of the glass bottle, the first and the second sleeves contact the interior side of the metal bottle in a snug-fit manner, when the glass bottle in nested therein.

8. A multi-configuration, reusable bottle assembly, comprising:
a bottle cap;
a metal bottle that defines an interior volume for retaining liquid, the metal bottle includes
an upper portion the upper portion includes a neck that defines an opening, the upper portion having a cylindrical body, including an insulative, double-walled side wall, the neck includes threads that mate with corresponding thread of the bottle cap in a watertight manner, and
a lower portion having a cylindrical body, including an insulative, double-walled side wall,
wherein the upper portion and the lower portion removably mate with each other in a watertight manner to define the interior volume, and when detached, the upper portion and the lower portion can both independently serve as cups for retaining liquid; and
a glass bottle sized to securely and removably nest within the interior volume of the metal bottle, the glass bottle further sized to extend out the opening of the metal bottle so that an opening of the glass bottle directly mates with the bottle cap, forming a watertight seal therebetween.

9. The multi-configuration, reusable bottle assembly as defined in claim 8, wherein the bottle cap includes a cylindrical base that mates with the neck of the metal bottle, a flip top that is attached to the base via a hinge, and a latch that engages the base and the flip top for securing the flip top, the flip top is positioned to seal the opening of the glass bottle in a watertight manner, when closed.

10. The multi-configuration, reusable bottle assembly as defined in claim 9, wherein the bottle further includes removable spout for use with the glass bottle is removed, the spout is disposed between the base of the cap and the metal bottle in a watertight matter, when in use, the spout projects upward through an opening of the base, when the top is flipped open, so that the user can drink directly through the spout.

11. The multi-configuration, reusable bottle assembly as defined in claim 8, further comprising a separable silicone grip sized to fit about a top opening of the lower portion of the metal bottle, when separated from the upper portion, serving as a grip, in a can cooler configuration.

12. The multi-configuration, reusable bottle assembly as defined in claim 8, wherein:
the upper portion defines a bottom opening and includes threads disposed about an outer side a sidewall of thereof, proximate to the bottom opening, and
the lower portion defines a top opening and includes threads disposed on an inner side of a sidewall thereof, proximate to the top opening, to mate with the treads of the upper portion forming a watertight seal therebetween.

13. The multi-configuration, reusable bottle assembly as defined in claim 8, wherein the glass bottle includes a first sleeve disposed about a neck of the glass bottle, and a second sleeve disposed about a base of the glass bottle, the first and the second sleeves contact the interior side of the metal bottle in a snug-fit manner, when the glass bottle in nested therein.
